(19) United States
(12) Patent Application Publication
(10) Pub. No.: US 2005/0153646 A1
(43) Pub. Date: Jul. 14, 2005

(54) Coin hopper

(76) Inventors: Hiroshi Abe, Iwatsuki-shi (JP); Takashi Inozuka, Iwatsuki-shi (JP)

Correspondence Address: SNELL & WILMER L.L.P., Suite 1200, 1920 Main Street, Irvine, CA, 92614-7230, US

(21) Appl. No.: 11/008,866

(22) Filed: Dec. 10, 2004

(30) Foreign Application Priority Data
Dec. 12, 2003 (JP) 2004-247722
Aug. 27, 2003 (JP) 2003-414354

(51) Int. Cl. G07D 1/00

(52) U.S. Cl. 453/49

(57) ABSTRACT

The invention promotes a smooth agitation and efficient transport of coins by setting the rotation direction of the agitator in the same direction as the rotary disc to move a center of rotation of the agitator to a location where most coins are collected.

### FIELD OF THE INVENTION

The present invention relates to a coin hopper which is used for dispensing coins stored in a coin bowl in bulk. Incidentally, the coins include officially current coins, substitute coins such as medals and tokens for game machines, and similar coins.

### BACKGROUND OF THE INVENTION

Conventionally, various types of apparatus are known as apparatus for dispensing disc-like coins.

For example, patent document 1 discloses an apparatus in which a stack wheel is provided on the front of a top section of a pinwheel, a plurality of pins are provided on the circumference of the pinwheel between a circumferential section of the pinwheel and a circumferential section of the stack wheel in a radial manner. Furthermore an agitator shown in such a manner that the agitator shown in the drawings which has three projections is anchored on a central section of the stack wheel to agitate the coins in the hopper.

This apparatus is constituted in such a manner that the pinwheel, the stack wheel, and the agitator are mutually integrally rotated with a cone-like body with the result that the apparatus is rotated in the hopper in the same direction at the same number of rotation.

At first, the coins reach a groove from the hopper. Since the pinwheel and elements associated with the pinwheel are arranged at a certain angle, coins are moved into the groove with the weight thereof. Thereafter, the coins are agitated with the agitator, and are engaged with an outer pin of the pinwheel. Coins can take a mutually stacked posture until the coins reach a position corresponding to two o'clock of a clock.

The wiper is engaged with coins which are stacked to sweep down the coins into the hopper. The coins which pass above the top section of the stack wheel are engaged with the knife. Thereafter, the coins proceed by crossing the knife. Then, the coins are discharged into the exhaust chute in an accelerated manner. The chute has a coin deflector which is engaged with coins to deflect the coins toward the center. Thereafter, the coins are discharged freely to the outer.

The knife is mounted on a axis in such a manner that the attachment position thereof can be freely adjusted. Consequently, the stack plate having each kind of diameters and the agitator are located on the pinwheel so as to accommodate the coins having different sizes (see Patent Document 1, referred to as the prior art)

Furthermore, the patent document 2 discloses that the supply ring and the agitator are rotated in a direction opposite to each other by starting the drive motor in the state in which the coins are accommodated in an irregular manner with the result that coins which are fixed to the inner surface of the supply ring are picked up with a coin supply claw and a fixed vertical support plate while agitating the coins in the hopper so that the coins are sent to the coin dispensing opening located above while applying a press force to the surface.

In particular, this apparatus is intended to improve the picking up of coins in the hopper with the supply ring, and the device comprises a plate-like agitating member having a plurality of radial arms made of synthetic rubber which is fixed with a pressure plate and a screw on a disc so that the plate-like agitating member is projected from the front side surface of the support plate by locating the disc in the disc hole formed on the vertical support plate at a position corresponding to, the lower half section inside of the supply ring.

Consequently, the coins agitated with the agitator are agitated with the agitator which is rotated reversely with respect to the supply ring in the hopper to be efficiently picked up with the supply jaw of the supply ring (see Patent Document 2, referred to as a second prior art).

In the first prior art, as the coins are moved to the side of the rotation direction of the pinwheel while being agitated with the agitator, the movement of the coins becomes slow at positions corresponding, for example, to direction of 6 to 5 o'clock or 4 o'clock of a dial of a clock as seen from the front surface, so that the many coins tend to be concentrated.

At locations where the movement of the coins becomes slow, the convection of the coins starts to each other with the result that the coins are not introduced into the coin transport passage Pa comprising a pinwheel and a stack wheel with the coins which move in a mutually opposite direction with the result that an idle state is generated.

As a consequence, in the coin transport passage Pa, an irregular dispensing of the coins is generated, and an idle dispensing of the coins is generated with the result that the dispensing efficiency is poor and an accurate dispensing of the predetermined coin cannot be conducted.

Furthermore, the agitator cannot go so far as to agitate the coins in the vicinity of the bottom section of the hopper because the shaft core of the output shaft is rotatably supported on the center of the hopper. Thus, the agitation efficiency is further deteriorated.

Furthermore, with respect to this apparatus, it is required that adjustment parts such as a wiper and a knife are required to be arranged as a countermeasure for maintaining a separation of the coins in the dispensing track of the coins and a stable dispensing posture of coins or a countermeasure for preventing the joggling of coins in the dispensing output. For this portion, the number of parts becomes large, so that the cost is heightened while the adjustment of the wiper and the knife is required every time the stack wheel is exchanged with the result that it takes a long time to manufacture and assemble the machine and the work thereof is very troublesome.

Furthermore, the stack wheel of this machine is rotatably and exchangeably provided on the tip section of the pinwheel. In accordance with the size of the coins to be applied, the stack wheel has a size of a diameter having a predetermined relation with the diameter of the pinwheel.

However, the pinwheel is fixed to the stack wheel which can be exchanged and the pins which are provided there are arranged in a definite distance.

Consequently, in the case where the stack wheel is exchanged in correspondence to the size of the coin, a shift is generated in a position relation with respect to the pin of the coin which is delivered between the stack wheel and the pin with the result that it is feared that an irregular dispensing of the coins is generated or the dispensing of the coins becomes unstable.

In the second prior art, since the coins are pressed with the pressure force with the supply claw of the supply ring and the pressure of the plate-like agitating member of the agitator which is reversely rotated to be agitated, the coins provide a large friction and resistance factor with respect to the agitator which has a larger number of revolution than the supplying ring has and which is reversely rotated so that it is feared that the agitating member is fractioned, the life of the member itself is shortened, and the coins themselves are damaged with the agitating member which is deteriorated and damaged.

Furthermore, there is also a problem in that the agitating member must be exchanged in a short time.

### SUMMARY OF THE INVENTION

The present invention has been made to solve the aforementioned problem. A first object of the invention is to provide a coin hopper which efficiently collects the coins, and can dispense the coins.

A second object of the present invention is to provide a coin hopper which is free from the generation of the joggling.

Furthermore, a third object of the present invention is to provide a coin hopper in which the application scope of the coin size is widened.

The coin hopper according to the present invention comprises a hopper bowl for storing coins in bulk stacked state, a rotary disc for receiving and dispensing coins in the hopper bowl one by one between a plurality of coin anchors which are inclined in an upward direction at a predetermined angle and are arranged in a predetermined distance, a fixed guide which has a smaller diameter than the rotary disc and has a concentric configuration than the rotary disc and which is projected in a predetermined amount toward the hopper bowl of the rotary disc, and an agitator which is projected in a predetermined amount toward the hopper bowl than the fixed guide and is located on a lower side with respect to the rotation shaft of the rotary disc.

According to the present invention, the coins are agitated in association with the rotation of the rotary disc by placing the agitator at a position which is moved in a downward direction with respect to the center of the rotation which is formed by the rotation disc. Consequently, the coins on the bottom section of the hopper bowl can be efficiently agitated. Furthermore, the coins can be agitated with the agitator at a location where many coins are concentrated with the same rotation of the agitator and the rotary disc with the result that the coins can be efficiently picked up to be efficiently introduced and transferred into the coin movement passage which comprises a rotary disc and the fixed guide.

The coins which are anchored to the anchor of the rotary disc are moved to the dispensing port while being guided to the circumference of the fixed guide. Consequently, the knife is not used unlike the prior art, so that the adjustment thereof at the time of the change of the coin diameter is not required and the number of parts can be decreased, which leads to the cost reduction.

Furthermore, it is not feared that the idle transport of the coins into the coin transport passage and an irregular transport of coins as seen with the conventional machine is generated, and the transport efficiency can be largely improved.

Furthermore, the set position of a coin sensor can be changed to fit to the diameter of the coins, and the rotary disc and the fixed guide can be changed to be fit to the diameter of the coins with the result that the application scope of the coins to be dispensed can be widened.

Furthermore, the agitator can be rotated on the axis which forms a different rotation center at a lower position of rotation center of the rotary disc. Consequently, the agitator can be rotated at a rotation number different from that of the rotary disc or in a rotation direction different from that of the rotary disc with the result that the agitation efficiency and the transport efficiency of the coins can be improved.

Furthermore, a pressure force is given to the coins between the plurality of arms to activate the movement of the coins thereby moving the coins. Consequently, at a location where many coins are collected, the coins are agitated to rotate the posture and position of the coins at random with the result that many coins can be located at the coin transport passage.

Furthermore, the friction resistance at the time of the contact the coins with the agitator is alleviated, and the agitator is rotated in the same direction of the rotary disc with the result that the abrasion of the agitator is suppressed and the endurance life thereof can be prolonged.

Furthermore, the coins which are transported to the coin transport passage are arranged in a row while holding a stable posture for each piece of the coins, and the coins are guided to the side of the coin transport port so that each piece of the coins can be smoothly delivered.

Furthermore, the transport posture of the coins can be stabilized and can endure the aging friction particularly resulting from the contact of the metal-made coins.

Furthermore, the piece can be exchanged with a piece corresponding to the coins and the worn piece can be exchanged with a new piece.

Furthermore, the coins which move into the horizontal coin transport guide can be dispensed toward the coin sensor one by one with the dispensing roller with the result that the joggling of the coins in the chute can be prevented, and the counting and dispensing of the coins can be performed quickly and accurately.

Furthermore, the coin sensor is not projected toward the coin transport passage, so that there is no direct physical effect given by the joggling of the coins which is feared to be generated in the coin transport passage thereby enabling the breakage of the coin sensor.

Furthermore, the coins do not interfere with the coin sensor between the coin sensor and the dispensing roller by providing an appropriate distance between the coin sensor and the dispensing roller. Consequently, an erroneous operation of the coin sensor by the coins can be prevented so that the coins can be counted accurately.

Furthermore, since the unallowable coins blocking piece is arranged in the coins transport passage, unallowable coins having a large diameter are blocked away from the transport passage with the blocking piece. Consequently, the unallowable coins are blocked and the unallowable coins do not move into the chute. Consequently, the joggling of the coins in the chute can be prevented in advance.

Furthermore, the coin sensor can be moved and adjusted together with the unallowable coins blocking piece in a direction perpendicular to the coin transport passage in correspondence to the diameter of the coins with the result that the coins can be accurately counted in correspondence to the coins, and the coin sensor and the coins do not interfere with each other in the chute.

Furthermore, a power transmission system can be constituted in which the agitator is rotated with the first transmission gear which is engaged with the drive gear, and the rotary disc is rotated in the same direction as the transmission gear which is engaged with the second transmission gear which is integrally formed on the first transmission gear. Consequently, the agitation efficiency of the coins and the transport efficiency of the coins can be improved with a compact structure.

Furthermore, the coins can be efficiently and smoothly transported in correspondence to the coins having a wide scope of application by appropriately exchanging and assembling the rotary disc and the fixed guide with the rotary disc and the fixed guide for exchange which correspond to the coins. As a consequence, it never happens as seen in the prior art that a disadvantage in the transport of the coins such as the irregular transport of the coins or the like resulting from the shift in the position relations between the coins and the pins as a result of the change in the coin size.

### BRIEF DESCRIPTION OF THE DRAWINGS

FIG. 1 is s perspective view showing a whole of a coin hopper according to Embodiment 1 of the present invention.

FIG. 2 is a perspective view showing a state in which the hopper bowl according to Embodiment 1 of FIG. 1 is detached.

FIG. 3 is a front view of FIG. 2.

FIG. 4 is a rear view of FIG. 3.

FIG. 5 is a partially enlarged view of FIG. 4.

FIG. 6 is a left side view of FIG. 4.

FIG. 7 is a perspective view of a central vertical cross section.

FIG. 8 is an explanatory view showing a wheel structure according to Embodiment 1 of the present invention.

FIG. 9 is a plan view showing a rotary disc.

FIG. 10 is a plan view showing a fixed guide.

FIG. 11 is a view showing a transmission mechanism according to Embodiment 2.

FIG. 12 is a broken view of a one-way clutch and a transmission gear.

FIG. 13 is a front view showing a state in which the one-way clutch is pressed into the transmission gear.

FIG. 14 is a front view showing a rotary and a guide roller according to Embodiment 2.

FIG. 15 is a front view showing another structure of the agitator and the unallowable coins blocking piece.

FIG. 16 is a perspective view showing another structure of the agitator and the unallowable coins blocking piece.

### DESCRIPTION OF THE PREFERRED EMBODIMENT

A hopper bowl for storing coins in bulk stacked state is provided before a base and a rotary disc having a plurality of anchors which are arranged in a predetermined distance, a fixed guide which is arranged on the rotary disc and which has a smaller diameter than the rotary disc and has a concentric configuration and is projected in an appropriate thickness, and an agitator which is projected to the hopper bowl than the fixed guide in a predetermined amount to agitate coins in the hopper bowl in bulk stacked state to discharge the coins efficiently.

### Embodiment 1

Hereinafter, forms of embodying the coin hopper according to the present invention will be explained in detail by referring to drawings on the basis of embodiments.

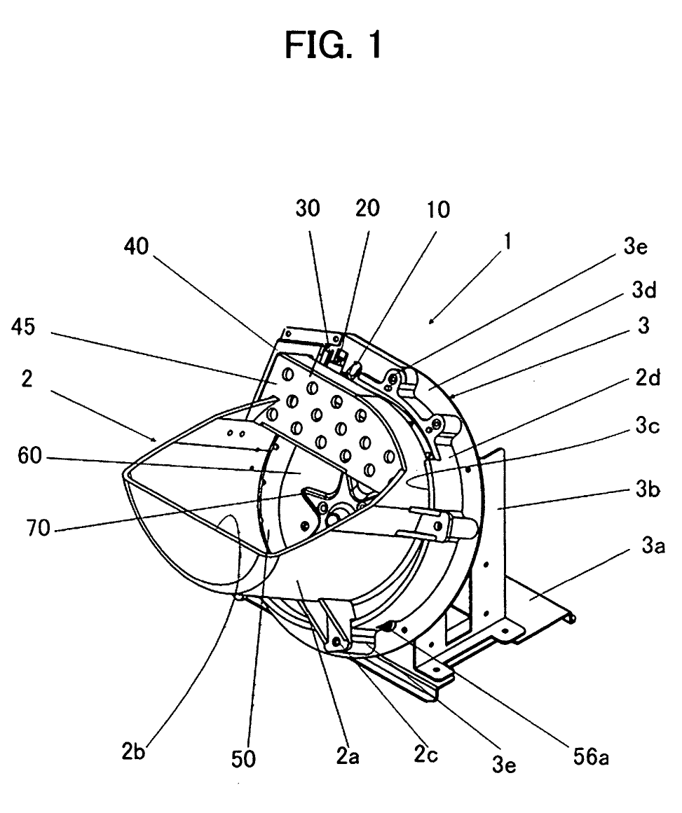

FIG. 1 is a perspective view showing a whole of the coin hopper according to Embodiment 1 of the present invention.

As shown in FIG. 1, the coin hopper 1 according to Embodiment 1 of the present invention has a hopper bowl 2 for storing a plurality of coins in bulk stacked state, and a main body 3 of the hopper for supporting and fixing the hopper bowl 2 in an upwardly inclined state.

Furthermore, the hopper bowl 2 has a hopper head section 2a which is projected in a forward direction than the main body 3 of the hopper and has a configuration having an increasing deepness and being inclined toward the agitator 70, a coin inlet port 2b for allowing the coins in an upward direction, a projection section 2c for the attachment and fixture on the main body 3 of the hopper 3, and an fitting body section 2d for fitting on the main body 3 of the hopper.

Furthermore, the main body 3 of the hopper has a horizontal placement base section 3a, a support side wall section 3b which is erected approximately vertically with respect to the placement base 3a, a ring-like fitting section 3c for receiving the fitting body section 2d, and a base section 3d which is integrally formed on the ring-like fitting section 3c, and a hopper bowl attaching section 3e which is integrally formed on the ring-like fitting section 3c, and the main body 3 of the hopper is fixed in an inclined manner in an upward direction via the base section 3d to the support side wall section 3b.

On the main body 3 of the hopper, there are provided a dispensing roller attaching section 10, an unallowable coins blocking piece 20, a coin sensor attaching section 30, a chute 40, and a coin cover 45 at a location on the upper left as seen in the drawings. There are provided a rotary disc 50, a fixed guide 60, and an agitator 70 respectively over the bottom portion of the hopper bowl 2 toward the forward direction at the central position as seen from the surface of the drawings.

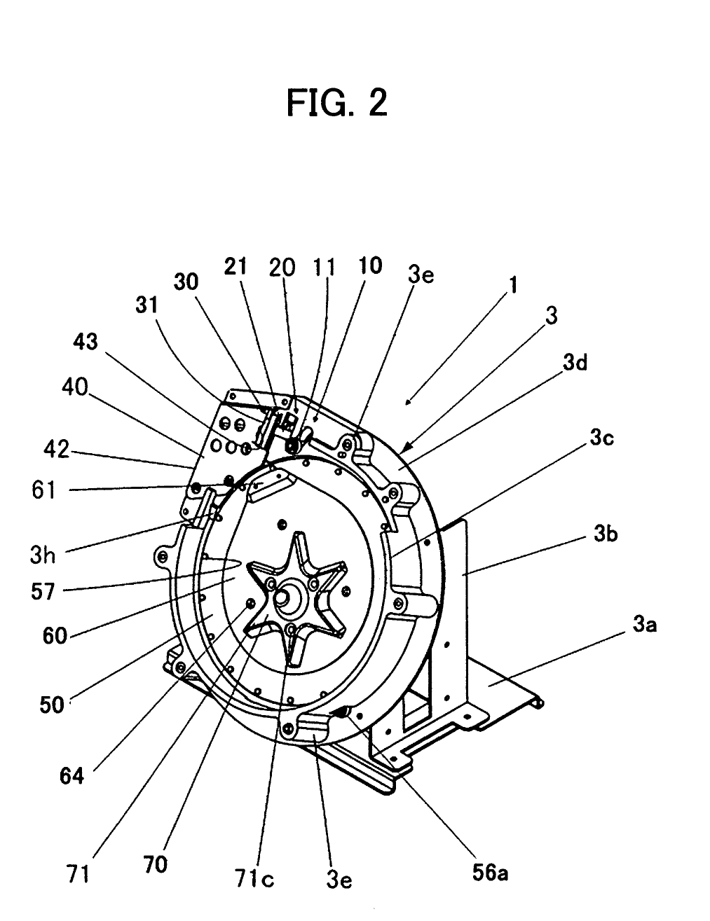

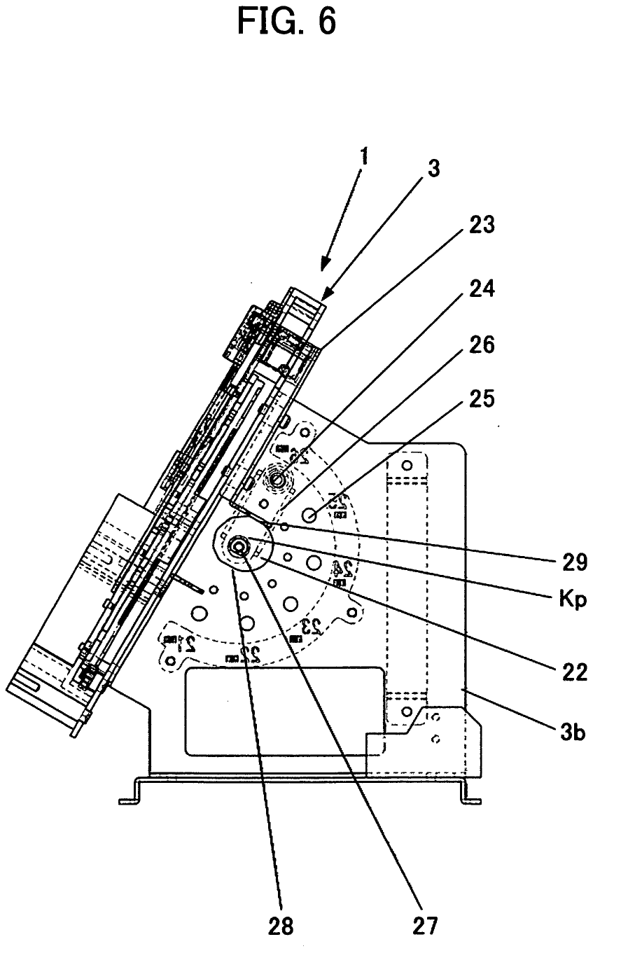

The coin hopper 1 will be described in detail by using FIGS. 2 to 10. On the main body 3 of the hopper, a ring-like jaw section 3g I is integrally formed on the lower section of the inner circumferential side wall 3f for forming the ring-like engaging section 3c at a location in the vicinity of the center as seen in the drawings.

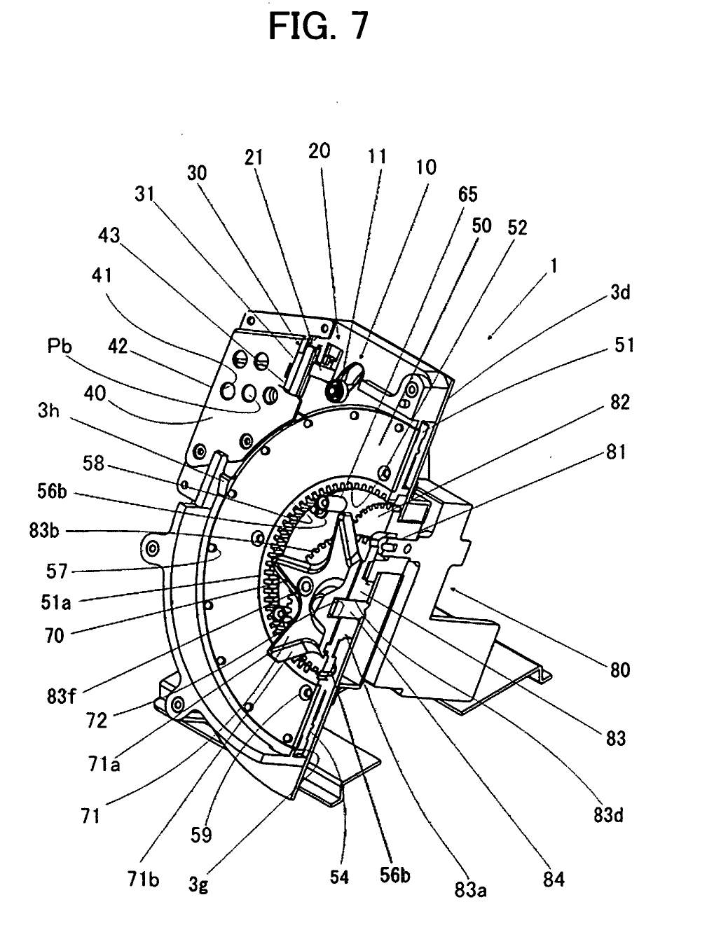

This ring-like jaw section 3g is provided for supporting an outer circumference of the upper surface of the rotary 51 which is inserted between the section 3g and the base section 3d, and which is shown in FIG. 7.

Furthermore, as shown in FIG. 7, on the surface of the ring-like jaw section 3d, there are arranged a piece 3h for preventing the coins from jumping the hopper. The piece 3h for preventing the coins from jumping the hopper is located at a position a little above the rotation center P of the rotary disc 50. The upper surface of the piece 3h is located at an approximately vertical position with respect to the placement base section 3a. The surface thereof is extended from the surface of the ring-like jaw section 3a toward the chute 40 at an angle of looking in an upward direction. The coins are allowed to float from the rotary disc 50 to fall into the lower hopper bowl 2. In the case where the coins move to the side of the chute along the inner circumferential side wall 3f, the coins are erected with this upper surface to allow the coins to fall into the hopper bowl 2 thereby preventing the coins from being stacked between the chute 40 and the coin anchor pin 57.

Incidentally, for the coin anchor pin 57, an anchor member such as a plate or the like may be used instead of the pin. Consequently, the coin anchor pin 57 may be described as an anchor body 57.

Furthermore, on a coin passage from the rotary disc 50 to the chute 40, a dispensing roller attaching section 10, an unallowable coins blocking piece attaching section 20, and a coin sensor attaching section 30 are arranged from the side of the disc 50. On the dispensing roller attaching section 10, a dispensing roller 11 is attached. On the unallowable coin attaching section 20, the unallowable coin blocking piece 21 is attached. On the coin sensor attaching section 30, a coin sensor 31 is movably attached. In particular, the unallowable coins blocking piece 21 and the coin sensor 31 are attached so that the two elements can be moved in a mutually associated manner.

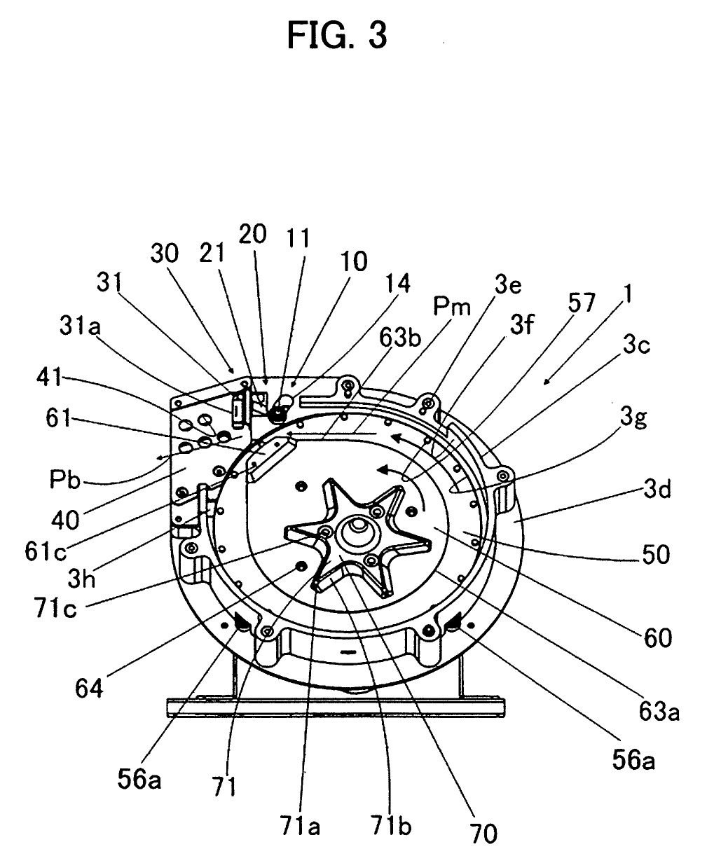

Similarly, the chute 40 on the left view of the drawing is formed in a cross section channel configuration. The inside surface 41 of the chute 40 and the upper surface of the base section 3d of the main body 3 of the hopper has a cross section having a rectangular configuration. As shown in FIG. 3, a coin transport passage Pb is formed which is inclined in a downward direction.

The unallowable coins blocking piece 21 is such that an inclined surface is formed which is projected at an angle of looking toward an inclined upward direction on the side of the chute 40 from the upper surface of the rotary disc 50. In other words, the piece 21 has an approximately right angle triangle configuration. The inclined surface is faced upward toward the chute 40 from the upper surface of the base section 3d. The piece 21 is fixed to slightly an outer of the passage of the allowed coins. The unallowable coins which are transported from the upstream coin delivering passage Pm and which have diameters which prevents the movement to the chute 40 are allowed to float from the rotary disc 50 to fall into the hopper bowl 2.

In the drawings, on the chute 40 a coin sensor 31 is formed which is integrally connected to the unallowable coins blocking piece 21. A coin transport passage Pb is formed with the inside surface 41 and the upper surface of the base section 3b. The chute 40 forms a metal-made lid configuration formed of a steel plate which is bent with plate processing or the like which a notch 43 is provided over a section at which the coin sensor 31, the unallowable coins blocking piece are moved. The left end of the passage Pb is a dispensing port 42.

The coin sensor 31 is provided at a position recessed from the inner surface 41 of the chute and the upper surface of the base section 3d, so that the coin sensor 31 is not projected into the coin transport passage Pb and is arranged in such a manner that an appropriate distance is provided with respect to the dispensing roller 11.

Furthermore, the coin sensor 31 is provided in such a manner that the coin sensor 31 can be moved in a direction perpendicular to the coin transport passage Pm together with the unallowable coins blocking piece 21 between the dispensing roller 11 and the chute 40.

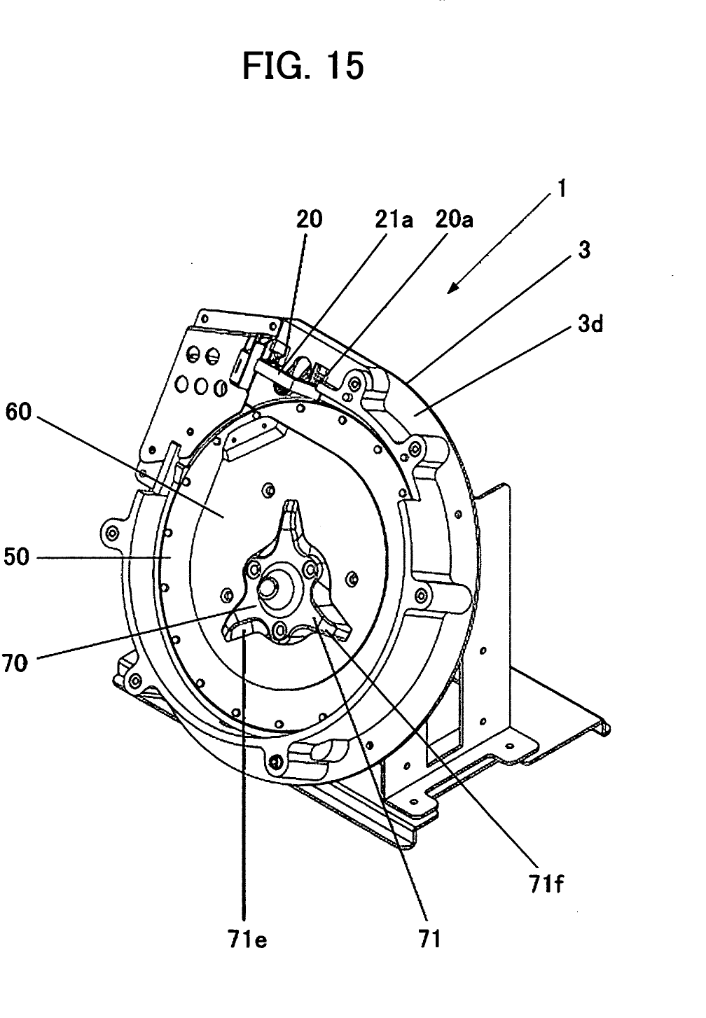

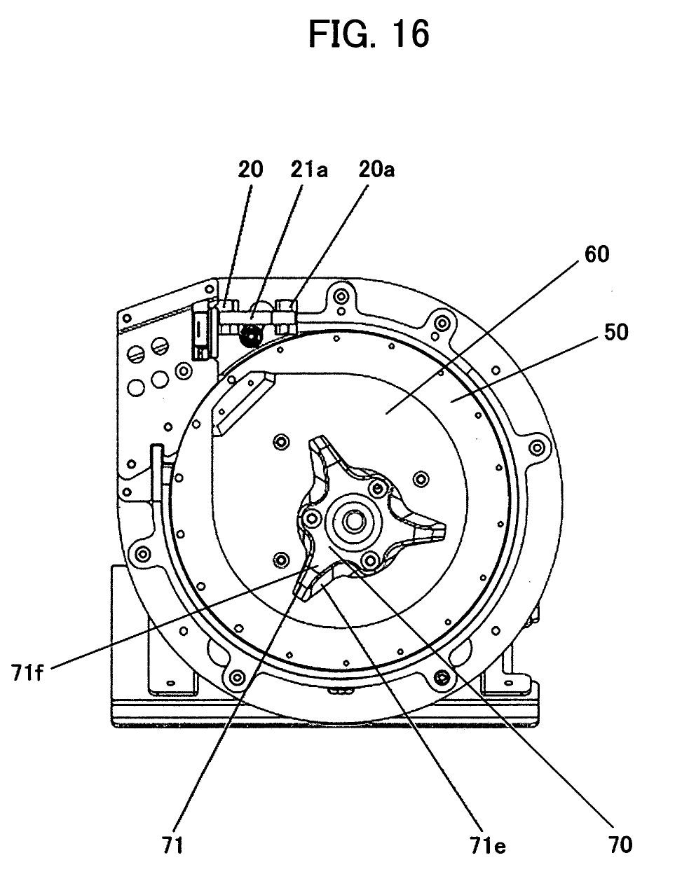

By using FIGS. 3 and 7, the unallowable coins blocking piece 21 is attached on the unallowable coins blocking piece attaching section 20. As another unallowable coins blocking piece, as shown in FIGS. 15 and 16, the coin passage has an unallowable coins blocking piece attaching section 20a, a dispensing roller attaching section 10, and an allowable coins blocking piece attaching section 20 from the side of the disc 50. By sandwiching the dispensing roller 10, the coin passage has the unallowable coins blocking piece attaching section between the unallowable coins blocking piece attaching section 20 and the unallowable coins blocking piece attaching section 20a. The unallowable coins blocking piece 21a is provided on both unallowable coins blocking piece attaching section 20 and 20a.

The unallowable coins blocking piece 21 has a long elongated plate-like configuration, and the end section on the side of the disc 50 is formed in an inclined configuration. Furthermore, the end section thereof is formed in a bridge-like configuration to prevent the piece 21a from contacting the dispensing roller 11 with the result that the end section is projected toward the upper side from the coin passage with a pillar not shown which is integrally formed on both sides of the piece 21a.

With the unallowable coins blocking piece 20, the unallowable coins which are energized after being dispensed with the dispensing roller 11 is brought back to the hopper head portion 2a. Furthermore, in the unallowable coins blocking piece 21a, it is constituted in such a manner that the unallowable coins which come from the disc 50 prior to dispensing the coins with the dispensing roller 11 are brought back to the hopper head portion 2a from the end section having an inclined surface configuration of the unallowable coins blocking piece 21a. In examples shown in FIGS. 3 and 7, it is feared that the coins are joggled between the chute 40 and the blocking piece 21 with the energizing of the coins. In examples shown in FIGS. 15 and 16, the unallowable coins are not energized so that the coins are allowed to fall in the coin bowl 2 with certitude.

Consequently, the unallowable coins blocking piece 21a may be used instead of the unallowable coins blocking piece 20.

In the aforementioned coin sensor 31, for example, the U-shaped electro-magnetic sensor is used, and the coin sensor 31a is arranged in such a manner that the U-shaped section embedded with the detection section 31a for detecting the coins to be detected is located on both sides of the passage Pb. The coin sensor 31 moves the notch section 43 in a direction perpendicular to the coin dispensing passage Pb while the width direction of the chute 40 is provided on the chute 40 in a manner of spanning the coin transport passage Pb along the inner surface 41 of the chute 40 and the upper surface of the main body 3 of the hopper.

That is, the detection section 31a of the coin sensor 31 is located on the chute 40 so that the section 31a is not projected into the coin transport passage Pb from the upper surface of the inner surface 41 of the chute and the base section 3d. That is, the coins do not collide with the detection section 31a.

Incidentally, in the coin sensor 31, not only an inverted U-shaped electro-magnetic sensor but also an inverted U-shaped optical sensor can be also used. A non-U-shaped electro-magnetic sensor can be also used. Furthermore, in the case of the non-U-shaped electro-magnetic sensor, the detection section is recessed from any surface on the side of the inner surface 41 of the chute or the side of the base section 3d to be located on the chute 40. In other words, such arrangement is provided for preventing the coins from colliding with the detection section.

In FIG. 3, about three fourth of the outer circumference of the fixed guide 60 is concentric with the rotary disc 50 and has a smaller diameter. One fourth of the outer circumference is extended in a direction of a tangent line. As a whole, the fixed guide has a tear-drop configuration. The fixed guide is formed of a plate-like body having at least two thirds of the thickness of a predetermined coin, for example relatively hard and rigid metal such as steel plate material or the like. The fixed guide is fixed to the base section 3d which is projected for the portion of the thickness with respect to the upper surface of the rotary disc 50.

A thickness of the fixed guide 60 is generally the same as the thickness of the coins. That is because two coins are stacked and are not guided in the dispensing guide 63a and 63b.

Furthermore, the fixed guide 60 is located on the rotary disc 50. The side surface of the outer circumference and the surface of the rotary disc 50 form a coin transport passage Pm.

That is, in the fixed guide 60, the thickness surface which forms an outer circumference side surface has a right angle surface with respect to the surface of the rotary disc 50. Then, the right angle and the surface of the rotary disc 50 form a coin transport passage Pm for guiding and moving the coins in a direction of the coin transport.

On the fixed guide 60, a round coin transport guide 63a and on the outer circumference of a round coin transport guide 63a, a horizontal coin transport guide 63b are formed which extend in a direction of the tangent line.

Furthermore, the horizontal coin transport guide 63b is detachably fixed to a different piece 61 on the side surface of the end section of the horizontal coin transport guide 63b in order to make the thickness thereof thicker than other round coin transport guide 63a with a view to correspond to coins having different thicknesses. Therefore, the thickness of the guide 63b exceeds the thickness of the coin. Furthermore, the guide surface of a different piece 61 is inclined to form an acute angle with respect to the upper surface of the rotary disc. In the case where the coins are pressed against the guide surface of a different piece 61 with the dispensing roller 11 because of this inclination, the coins are pressed against the upper surface of the rotary disc with the coin divisional force to be pressed out while preventing the coins from falling from the guide 63b. Incidentally, this different piece 61 and the transport guide section itself may be integrally formed to a thick thickness.

Furthermore, the different piece 61 forms a trapezoid configuration as seen from a plane surface, so that a hole 61c for screws for the attachment and fixture on the fixed guide 60 and the positioning pin not shown for positioning on the fixed guide 60 are embedded on the rear surface thereof.

Incidentally, the different piece 61 is formed of steel material in the same manner as the rotary disc 50. In particular, the steel is preferable which is quenched to endure abrasion with the passage of time resulting from the contact with a metal-made coins.

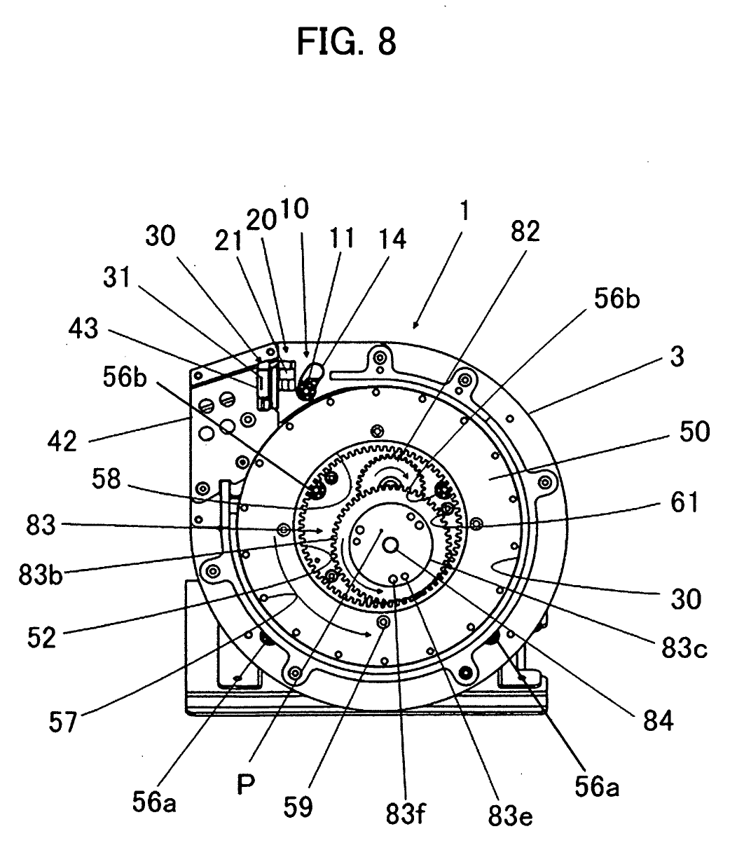

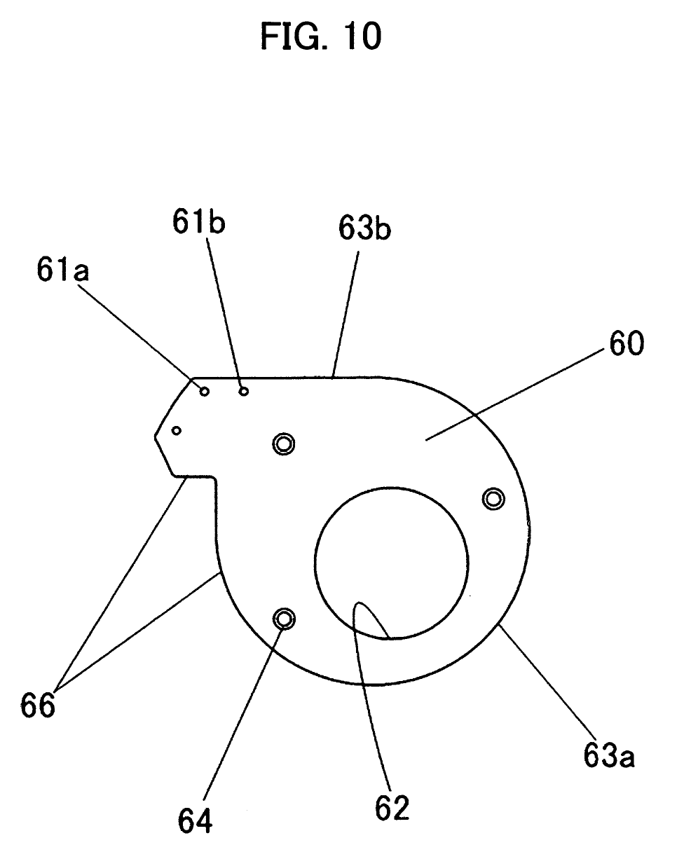

Furthermore, as shown in FIGS. 7 and 8 as well as in FIG. 10, a round hole 62 which enables the positioning of the projected surface 83c of the second transmission gear 83b, an attachment hole 61b for attaching and fixing the different piece 61 and a positioning hole 61a which allows the penetration of the positioning pin therethrough are penetrated on the fixed guide 60. Furthermore, an attachment hole 64 for attaching and fixing the different piece 61 to the base section 3d via the spacer 65 is also provided.

Since a round hole 58 of the fixed guide 60 is fit with a projection 83c of the second transmission gear 83b, the center thereof is slightly moved to the downward direction with respect to the central position P shown in FIG. 7 which forms the same axis with the rotary disc 50 while the hole is formed with a slight movement in a counterclockwise direction of the rotary disc 50.

Incidentally, this fixed guide 60 is attached and fixed to the main body 3 of the hopper with a slight space with respect to the rotary disc 50 to prevent the contact with the spacer 65.

In the case where the fixed guide 60 is located at a position higher than the center P of the coin located between the coin anchor pins 57 of the rotary disc 50, the fixed guide 60 is supported with the transport guide 63a and the upper surface of the rotary disc 50, and is pressed with the anchor pin 57 and rotates around the round transport guide 63a to be transported to the downstream direction through the coin transport passage Pm.

Furthermore, the coins are moved to the horizontal transport guide 63b which extends in a direction approximately in parallel with the tangent line direction of the fixed guide 60 and to the horizontal transport guide 63b which is attached with a different piece 61 located opposite to the dispensing roller 11 in the state in which the coins are arranged in a row one by one while being pressed with the coin anchor pin 57.

At this time, the coins are pressed to the side of the transport guide 63b with the dispensing roller 11. However, even in the case where the coins are pressed with the dispensing roller 11 with the different piece 61 owing to the thickness of the guide 63b, the friction is increased between the coins and the guide so that the coins do not fall. Even in the case of the configuration having a different thickness, or even in the case of a configuration in which the both side angles in the thickness direction is dangled, the coins are held on a horizontal transport guide 63b with the different piece 61.

Furthermore, the coins are moved against the energizing force of the dispensing roller 11 with the pressing force of the coin anchor pin 57. Immediately after the contact position of the dispensing roller 11 passes through the diameter section of the coins, the coins are dispensed out into the passage Pb with the return force of the dispensing roller 11.

At this time, the coins having an outer diameter which does not allow the passage through the coin transport passage Pb of the chute 40 collide with the inclined surface of the unallowable coins blocking piece 21 provided between the dispensing roller 11 and the chute 40 with the result that the upper end thereof is flipped in an upward direction and the coins are deviated from the passage Pb and driven out to fall into the hopper bowl 2.

Otherwise, the unallowable coins which comes from the disc 50 before dispensing the coins with the dispensing roller 11 are allowed to fall in such a manner that the unallowable coins are brought back into the hopper bowl 2 with the end section which section has an inclined surface of the unallowable coins blocking piece 21a.

Furthermore, either of these unallowable coins blocking pieces 21 and 21a moves up and down with respect to the coin transport passage Pb in association with the coin sensor 31 with the result that the piece 21 or 21a can be adjusted in an upward and a downward direction in advance in accordance with the outer diameter of the coins.

The coins which are dispensed with the dispensing roller 11 and have passed under the unallowable coins blocking pieces 21 and 21a move into the chute 40.

The coins which move into the chute 40 are detected with the coin sensor 31 which is provided spanning the vertical direction with respect to the coin transport passage Pb of the chute 40 in an appropriate distance with the dispensing roller 11. The coins are counted and the detection signals are counted with a counter not shown, and the counted number becomes the coin transport number. Then the coins are transported via the coin delivery outlet 42 of the chute 40.

The coins which are dispensed into this chute 40 are detected with the coin sensor 31 after being completely dispensed with the dispensing roller 11 because the dispensing roller 11 and the coin sensor 31 in the chute 40 are separated in an appropriate distance.

Furthermore, the coin sensor 31 is provided on the unallowable coins blocking piece attaching sections 20 or 20 and 20a along with moves up and down in the notch section 43 in such a manner that the detection section 31a runs across the coin transport passage Pb at a right angle along with the up and down movement of the unallowable coins blocking pieces 21 and 21a while the detection section 31a is not projected to the inside of the coin dispensing passage Pb from the inner surface 41 of the chute, and the upper surface of the base section 3d. As a consequence, even when the coins which are dispensed into the chute 40 are stacked and detained in the coin dispensing passage Pb of the chute 40 and the joggling of the coins are generated, the breakage of the coin sensor 31 resulting from the inner pressure of the coin joggling can be prevented.

The inner pressure resulting from the joggling of the coins which are detained in the coin transport passage Pb of the chute 40 is applied to the inner surface 41 of the chute and the upper surface of the main body 3 of the hopper with the result that the chute 40 and the main body 3 of the hopper protect the coin sensor 31.

In the case where the number of the coin transport from which the detection signal of the coin sensor 31 is counted reaches a predetermined number, a coin transport termination signal is output, the geared motor 80 is suspended and the coin hopper 1 is suspended.

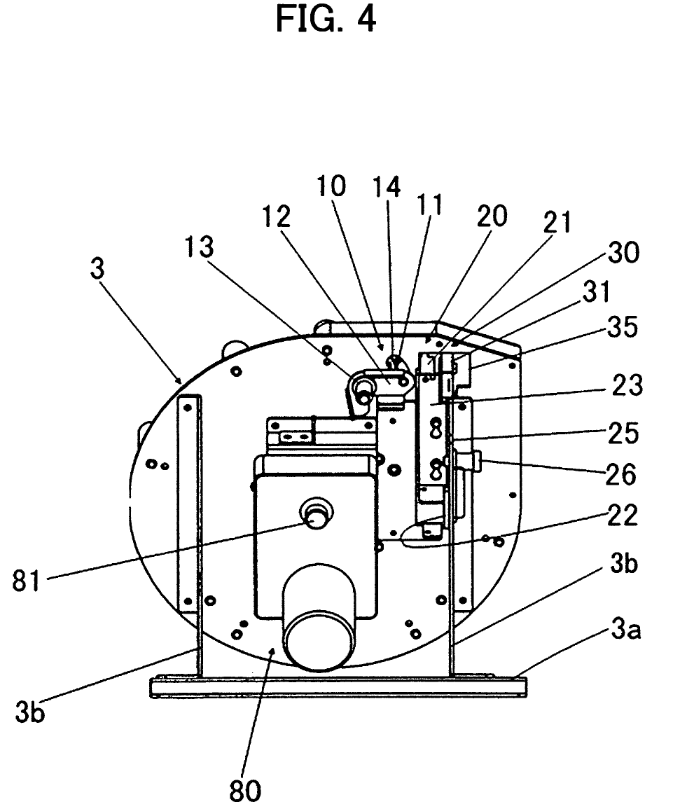

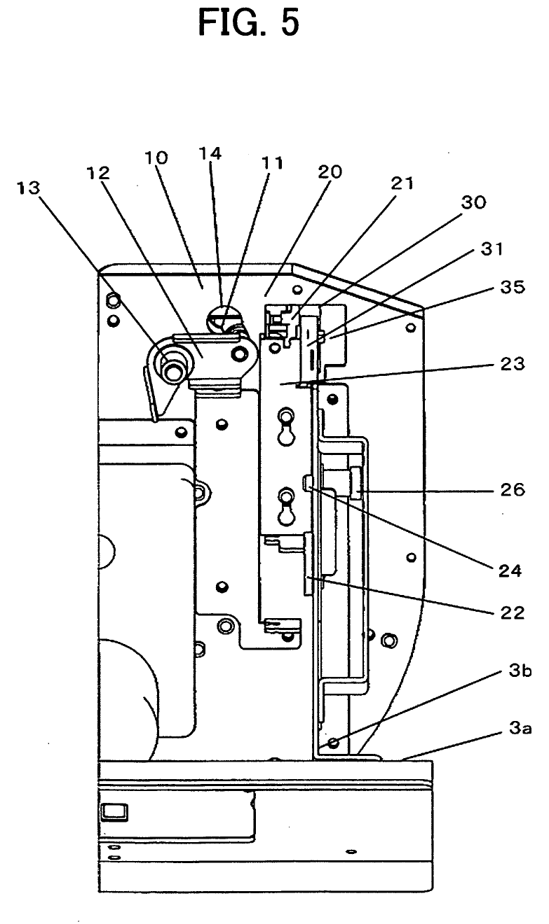

As shown in FIG. 4 and in FIG. 5 which is a partially expanded view of FIG. 4, a motor, for example, the geared motor 80, the dispensing roller attaching section 10, and the unallowable coins blocking piece attaching section 20, and the coin sensor attaching section 30 are arranged on the rear surface of the base section 3d.

The dispensing roller attaching section 10 comprises a dispensing roller 11, a rotation arm 12 which is rotatably and axially attached with the dispensing roller 11, a spring shaft 13 for constantly applying a downward elastic force to the rotation arm 12 with spring means not shown, and a long hole 14 for an elastic roller through which the dispensing roller 11 moves, wherein the dispensing roller 11 is exposed to the side of the coin transport passage Pm from the long hole 14 for elastic roller which is formed on the main body 3 of the hopper.

As shown in FIGS. 5, 6 or 15, the unallowable coins blocking piece attaching section 20 comprises a slider 23 for moving up and down the unallowable coins blocking piece 21 or the unallowable coins blocking piece 21a which is provided on the unallowable coins blocking piece attaching sections 20 and 20a, a cum 22 located on the lower section of the slider 23 for moving up and down the slider 23 with the rotation thereof, and a handle 26 rotatably fixed to the cum 22 for adjusting the rotation position of the cum 22 by rotatably attaching the cum 22, and selecting and rotating the plurality of notch holes 25 which are penetrated into the support side wall section 3b.

A plurality of notch holes 25 are provided on the support side wall section 3b along the diameter from the center of the rotation of the cum 22.

Incidentally, the cum 22 is provided with a cum shaft 27 by changing the center thereof from the center of the disc of the cum 22. As a consequence, the cum changes the center thereof and is rotated by rotating the handle 26 fixed to the cum shaft 27 with the result that the cum is bent in an angle-like configuration at the lowest position of the slider 23 contacting the cum 22 and the cum 22 can move up and down the lower plate 29 of the slider which extends in a direction of the cum 22. As a consequence, the slider 23 which is integrally formed with the lower plate 29 of the slider can be moved up and down. The lower plate 29 of the slider comes into contact with the cum 22 with the result that the projection section 24 of the handle 26 is inserted into the notch hole 25 to fix the cum 22. That is, the slider 23 is positioned and fixed. On the outer circumference of the cum, a plurality of sections corresponding to the notch hole 25 to which the cum 22 is fixed have a cum plane surface section 28 which is obtained by processing the outer circumference of the disc-like cum 22 in a plane-like configuration, so that the lower surface 29 of the slider closely contacts the cum 22.

In order to adjust in an upward and a downward direction the unallowable coins blocking piece 21 or the unallowable coins blocking piece 21a, the handle 26 is rotated in order to move up and down the slider 23 to select an appropriate notch hole 25 and to insert the projection section 24 at the end of the handle 26 into the notch hole 25 thereby deciding the adjustment position. As a consequence, since the cum 22 is suspended at a predetermined angle, the slider 23 is positioned at a position corresponding to the radius of the cum in this phase. In other words, the piece 21 or the piece 21a or the coin sensor 31 is held at the selection notch hole 25.

As shown in FIG. 7, in the perspective view of the central vertical cross section of the coin hopper 1, there is shown an output shaft 81 of the gear motor 80 positioned at the above right position of the coin hopper, a rotor 51 for rotating the rotation disc 50 and a transmission inner tooth gear 52 which is integrally formed on the center of the rotor 51.

In the aforementioned coin hopper 1, the geared motor 80 which is started by receiving a predetermined number of the coin transport signal rotates the rotary disc 50 and the agitator 70.

The power transmission or the like of the agitator 70 comprises a drive gear 82 axially attached on the output shaft 81 arranged on the main body 3 of the hopper, a transmission gear 83 having a second transmission gear 83b which is integrally formed with the first transmission gear 83a engaging with the drive gear 82, an axis 84 and a transmission gear 83 rotatably supporting the transmission gear 83 and located below the center P of the rotation of the rotary disc 50, and provided with a drive gear 82 on the downstream side in the rotation direction. The agitator 70 is formed on the second transmission gear. It is constituted in such a manner that the second transmission gear 83b is engaged with the transmission inner tooth gear 52 to rotate the rotary disc 50 fixed to the rotor 51.

That is, the output shaft 81 is rotated in a clockwise direction with the geared motor 80 while the first transmission gear 83a is rotated in a counterclockwise direction. The second transmission gear 83b which is rotated in a counterclockwise direction is engaged with the transmission inner tooth gear 52, to rotate the rotor 51 in a counterclockwise direction and to rotate the rotary disc 50 attached and fixed to the rotor 51 in a counterclockwise direction.

That is, the output shaft 81 is rotated in a clockwise direction with the geared motor 80 while the first transmission gear 83a is rotated in a counterclockwise direction. The second transmission gear 83b which is rotated in a counterclockwise direction is engaged with the transmission inner tooth gear 52, to rotate the rotor 51 in a counterclockwise direction and to rotate the rotary disc 50 attached and fixed to the rotor 51 in the counterclockwise direction.

It is constituted in such a manner that the second transmission gear 83b which is rotated in a counterclockwise direction with the first transmission gear 83a rotates the agitator 70 in a counterclockwise direction centering on the axis 84.

In this manner, the agitator 70 is rotated via the first and the second transmission gear 83a and 83b. Furthermore, the rotary disc 50 is rotated through the transmission inner gear 52 so that the agitator 70 is rotated in a counterclockwise direction to each other.

Consequently, the rotary disc 50 is rotated by receiving a power transmission from the gear 83 through the transmission gear 52, so that the rotation number of the rotary disc 50 is different from that of the rotator. The rotation ratio of the rotary disc 50 and the agitator 70 is preferably set to a scope of 5:6.

Consequently, even when the rotary disc 50 and the agitator 70 are rotated in a counterclockwise direction to each other, the agitation performance given to the coins becomes different.

Consequently, the agitator 70 moves the axis 84 which forms the rotation shaft in a downward direction with respect to the coaxial center P of the rotary disc 50 and the fixed disc 60 and forms a position which is moved toward the counterclockwise direction of the rotary disc 50.

The movement position of this agitator 70 approximately agrees with the position where the movement of the coins becomes slow, namely the position of 6 to 5 o'clock, and 4 o'clock on the dial of the clock as seen from the front surface of the main body 3 of the hopper as the coins are moved to the rotation direction of rotary disc 50 while the coins are agitated with the agitator 70.

At positions where a relatively large number of coins are collected, the movement of the coins becomes slow. That is because the coins are moved in the same direction with the rotation of the rotary disc 50. However, since the coins are dispensed one by one with the anchor, the coin which is not dispensed is detained. At this location, many coins can be agitated by positioning the agitator 70 to agitate many coins.

Besides, the rotary disc 50 has a rotation number different from the agitator 70. As compared with the agitator 70, the number of rotation is small, and the rotation speed is slow with the result that the agitator 70 agitates the coins and actively changes the posture of the coins by rotating in the same direction the agitator 70 having a large number of rotation and a high rotation speed on this rotary disc 50. Consequently, the coins can be easily hooked with the anchor and is hooked with the anchor without failure.

The agitator 70 has six arms 71 formed in a radial direction in a radial configuration and the agitator 70 assumes a star-like configuration. Consequently, the agitator generates a high synergic effect in the agitation, the movement and the scattering of the coins thereby improving the agitation efficiency. Furthermore, the arm 71 reduces a collision friction with a sharp end section 71a forming an acute angle toward the end and a coin escape surface 71b which is formed by forming an angle of depression on the side surface in the direction of rotation thereby alleviating a load applied on the agitator 70.

The agitator 70 has an appropriate thickness formed of synthetic resin excellent in anti-friction properties, for example, urethane rubber on the upper surface of the fixed guide 60.

Furthermore, on the central section of the agitator 70, an upper surface side has a cone-like configuration bulged in a cone-like configuration so as to be projected toward the side of the hopper bowl 2 and a lower surface side has a penetration hole 72 which is formed with a play on the head section of the axis 84.

On this agitator 70, an attachment hole 83f is penetrated in order to fix the agitator 70 on the circumference of the base section of the arm 71 with a screw of the second transmission gear 83b.

With respect to the agitator 70 which has six arms 71 formed in a radial direction in a radial configuration and which has a star-like configuration, as shown in FIGS. 15 and 16, the number of the arms 71 of the agitator 70 can be three. The sharp end section 71f which forms an acute angle toward the end, and the coin escape surface 71e which is formed by forming the side surface of the rotation direction at an angle of depression have a smooth arc-like inclined configuration than the sharp end portion 71a of the agitator 70 having six arms 71. Furthermore, the coin escape surface 71e has a larger escape angle than the coin escape surface 71b. In other words, an inclined angle for the coin escape is enlarged to a somewhat larger level.

In the case of the agitator 70 having six arms 71, the agitation properties are excellent whereas it sometimes happen that the coins penetrate into the escape surface 71b of the arm 71. However, the sharp end section 71f is formed is a smooth arc-like configuration, an escape angle of the coin escape surface 71e is made somewhat larger with the result that the coins can be smoothly guided to the side of the upper surface of the agitator 70 thereby inhibiting the penetration into the escape surface 71e of the arm 71.

Incidentally, the agitator 70 is formed in a star-like or an approximately triangular configuration. However, the configuration is not necessarily limited thereto. It goes without saying that the arm thereof can be a single arm which extends in a radial direction centering on the axis 84. Furthermore, the agitator 70 can be rotated in a direction reverse to the rotary disc 50.

Furthermore, in the drawings, with respect to the rotary 51, a projecting inner circumferential end 51a is formed which is projected in a concentric configuration so as to be fit the rotary disc 50 to surface agreement on the upper surface thereof while the rotary 51 has a circular hollow section 58 having a transmission tooth gear 52 formed on the projecting inner circumference 51a. The rotary 51 has a donut-like thin disc-like configuration formed of, for example, polyacetal, and acetal resin.

Furthermore, on the rotary 51, there is formed a ring-like groove 54 is through which a ring-like thrust bearing not shown is formed on the lower surface thereof. The rotary 51 is rotatably supported between the ring-like jaw section 3g and a base section 3d of the main body of the hopper shown in FIG. 3. Into the thrust bearing, a plurality of cone-like rollers are fit, for example into a ring-like support belt in an appropriate distance.

Furthermore, the attachment hole 55 is penetrated through the upper surface of the rotary 51 for integrally attaching and fixing the rotary disc 50.

Furthermore, as shown in FIG. 8, there are provided on the rotary 51, outer guide rollers 56a and 56a which contact the outer circumference side surface of the rotary 51 at a position lower than the central shaft and which rotates on the fringe of the two outer circumference surfaces in line symmetry with the respect to the vertical line which runs through the center of the rotary 51. Furthermore, there are provided on the inner circumference surface provided on the lower part of the transmission tooth gear 52 a total of three inner side surface guide rollers 56b, 56b, and 56b which rotate on the fringe of the inner circumference; two of the inner guide rollers contacting the inner circumferential side surface of the rotary 51 at an upward direction position than the central shaft and being located in line symmetry with respect to a vertical line passing through the center of the rotor 51; one roller being located on a vertical line passing through the center of the rotor 51 as shown in FIG. 7 and at a position immediately under the transmission inner tooth gear 52.

The rotary disc 50 has an outer diameter which is penetrated with a play into an inner diameter of the ring-like jaw section 3g of the main body 3 of the hopper while the rotary disc 50 forms a donut-like thin disc-like configuration having a round hole 58 having an inner diameter which is fit into the projecting inner circumferential fringe 51a of the rotary 51, the disc being formed of steel material.

Furthermore, a plurality of coin anchor pin 57 arranged in a predetermined distance are embedded on the upper surface of the rotary disc 50, and an attachment hole 59 for integrally fixing to the rotary 51 is penetrated therethrough.

A projecting surface 83c is formed which allows the fitting of the fixed guide 60 of the upper surface section of the second transmission gear 83b of the transmission gear 83 while a through-hole 83d for allowing the penetration into the axis 84, a hole 83e for positioning the agitator and suspending the rotation are penetrated. Furthermore, an attaching hole 83f for the agitator is provided thereon.

Incidentally, a thrust washer not shown is intervened between the upper surface of the main body 3 of the hopper and the first transmission gear 83a of the transmission gear 83 to prevent the lower surface of the gear from contacting the surface of the main body 3 of the hopper directly with the result that the gear is rotated smoothly on the main body 3 of the hopper centering on the axis 84.

This thrust washer is formed of, for example, resin comprising synthetic polymer compound and graphite particles, the thrust washer is free from plastic deformation, and has a small friction constant.

Here, when the application scope of the coins in the coin hopper according to the present invention is described, the slider 23 attached with and integrated with the coin sensor 31 is moved up and down in correspondence with the each kind of coin as has been described above thereby appropriately adjusting the position of the coin sensor 31 to adjust the position of the coin sensor 31 to the coin diameter.

For example, euro coins will be cited as an example for explanation. The diameter of 10-cent euro is 19.7Φ while the diameter of 2-euro coin is 25.7Φ. In the coin hopper 1 according to the present invention, the coins ranging from the coins having a diameter of 2 euro cent coin to the coins having a diameter of 10 euro cent coins can be transported without exchanging the parts only at the position adjustment corresponding to the coin diameter of the coin sensor 31.

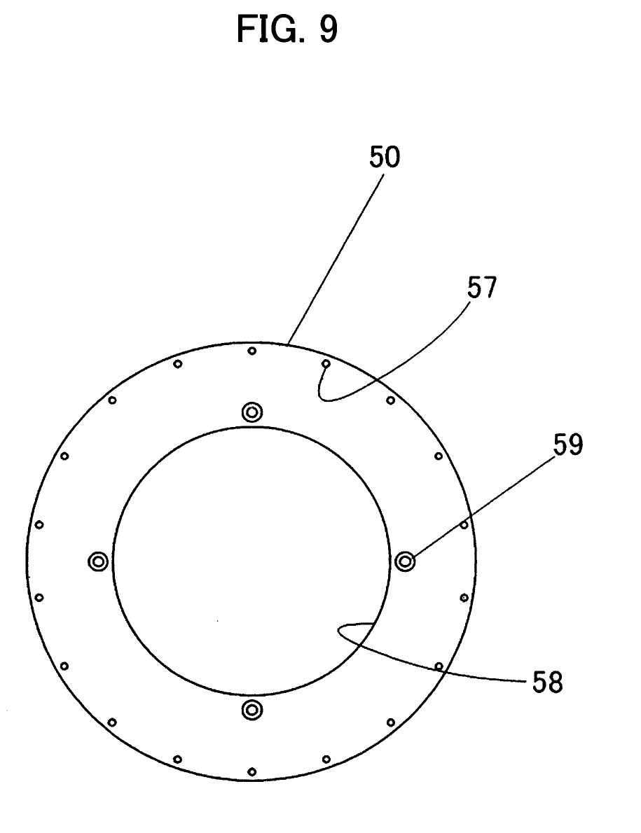

Furthermore, in order to conform to the coins of 25.7Φ or more, it becomes possible to correspond to the coins having a large diameter from 26Φ to 38Φ by exchanging the rotary disc 50 and the fixed guide 60 shown in FIGS. 9 and 10 so as to correspond to the coin diameter having a large diameter. Specifically, the part 63a is further exchanged with a fixed disc having a smaller diameter, and the rotary disc is exchanged with the rotary disc 50 having a larger distance of the anchor 57.

Furthermore, it is possible to correspond to and to handle many kinds of coin transport with one coin hopper by assembling the rotary disc for exchange and the fixed guide for exchange in correspondence with the coin size.

Even when the rotary disc for exchange and the fixed disc for exchange are exchanged with the rotary disc and the fixed disc corresponding to the coin size in this manner, the coins are transported at a stable posture while moving and supporting the coin hopper with the coin anchor pin 57 of the rotary disc and the transport guide of the fixed guide thereby counting and transporting the coins. Unlike the conventional apparatus, it never happens that a transport disparity is supplied owing to an unstable transport of the coins resulting from a shift in the position of the pin and the coins every time the assemblage of the stack wheel and the pinwheel are changed with the result that the coins can be transported in an efficient and stable manner.

Furthermore, as shown in FIG. 10, an escape guide 66 which is formed by notching the lower part of the horizontal coin transport guide 63b attached with a different piece 61 is formed on the fixed guide 60. It is preferable to form a place of escape of coins which moves in a reverse direction with respect to the agitator 70 and the rotary disc 50.

### Embodiment 2

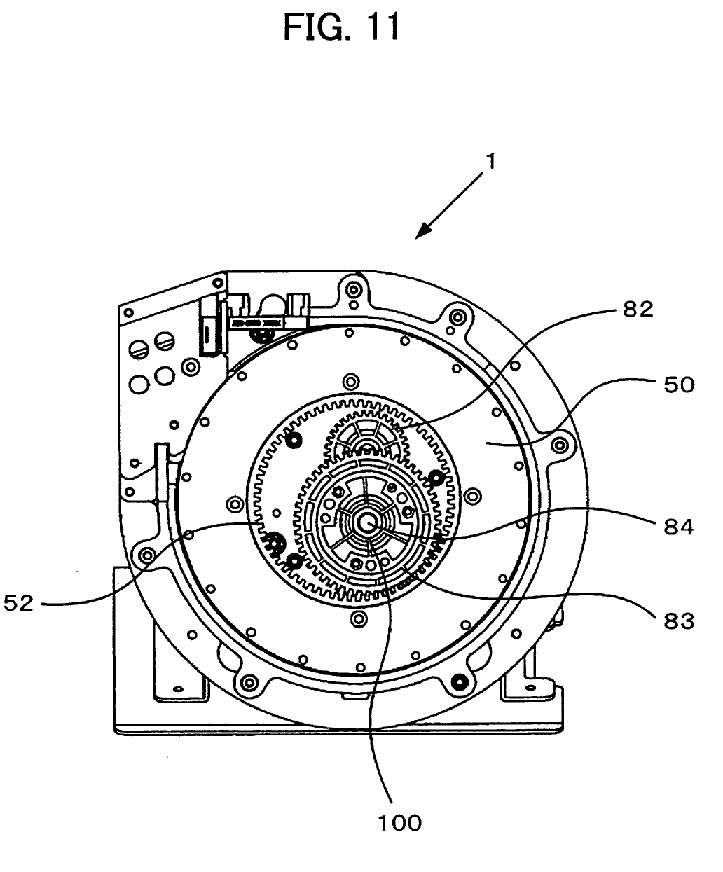

Next, by referring to FIGS. 11 through 14, Embodiment 2 of the present invention will be explained. The same structure as Embodiment 1 will be denoted by the same reference numeral. Incidentally, the basic structure of the present invention is the same as the structure of Embodiment 1 which has been explained by using FIGS. 1 through 10. Consequently, since an explanation on the basic structure explicated in Embodiment will be overlapped, the explanation on the basic structure will be omitted with respect to Embodiment 2.

FIG. 11 is a view showing a transmission mechanism of Embodiment 2 in the coin hopper 1.

Embodiment 2 shown in FIG. 11 comprises a rotary disc 50 for dispensing coins one by one with a plurality of coin anchor pins 57 arranged in a predetermined distance, a transmission inner tooth gear 52, a drive gear 82, a transmission gear 83, and a one way-clutch 100 for preventing a reverse of the axis 84.

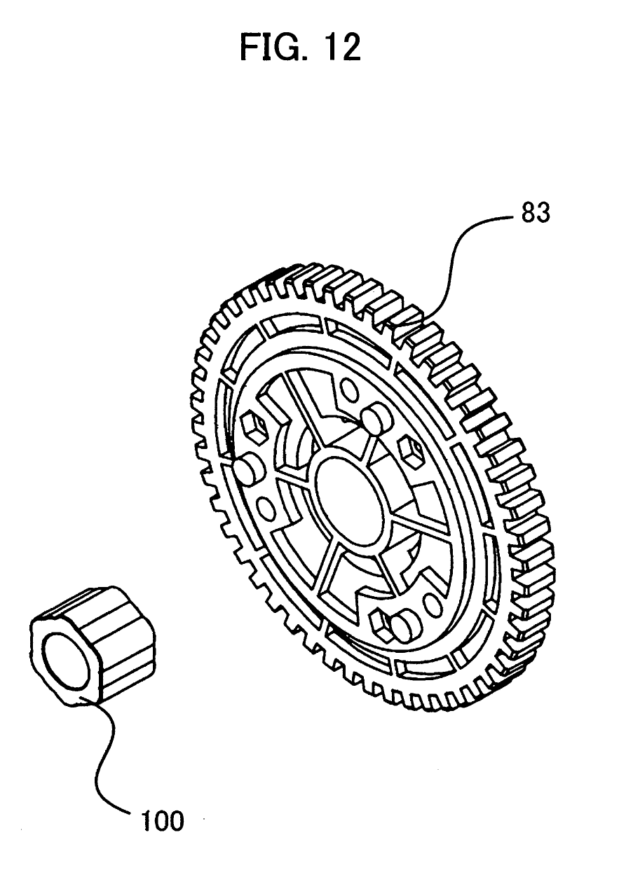

FIG. 12 is a broken view of the one-way clutch 100 detached from the transmission gear 83 prior to pressing and fixing the one-way clutch having a function of preventing the reversion of the transmission gear 83 into an axial hole of the transmission gear 83.

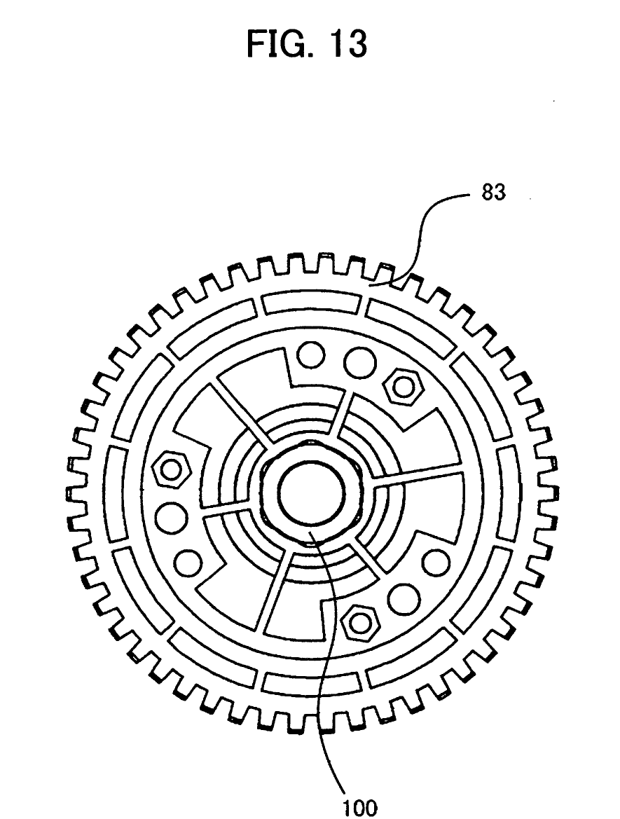

Furthermore, FIG. 13 is a front view of the transmission gear 83 into which the one-way clutch is pressed which has on an axial hole of the transmission gear 83 a function of preventing the reversion of the transmission gear 83.

It is possible to alleviate the back rush of the rotation disc by pressing and fixing the one-way clutch 100 to a central shaft of the transmission gear 83. Consequently, in the case where the transmission gear 83 does not have a structure without the one-way clutch 100, the back rush of the drive gear and the back rush of the transmission gear 83 are transmitted to the transmission inner tooth gear 52 so that the back rush of the transmission inner tooth gear 52 is increased.

That is, the drive gear 82 is rotated in a clockwise direction with the geared motor 80, and the transmission gear 83 having an integral constitution of the first transmission gear 83a and the second transmission gear 83b are rotated in a counterclockwise direction. Then, the one-way clutch 100 is also rotated in a counterclockwise direction together with the transmission gear 83. With respect to the transmission gear 83 which allows the intervention of the one-way clutch 100 between the transmission gear 83 and the axis 8, whose reverse rotation is suppressed can be rotated only in the counterclockwise direction. In the case where the drive gear 82 and the transmission gear 83 are suspended, the tooth of each gear comes into contact with the transmission gear 83 only in the direction of the counterclockwise direction in the engagement of the gear tooth of the drive gear 82 and the gear tooth of the second transmission gear 83b constituting the transmission gear 83. Consequently, the back rush of the whole gear is eliminated, thereby alleviating the load to respective gears and the friction of the gear.

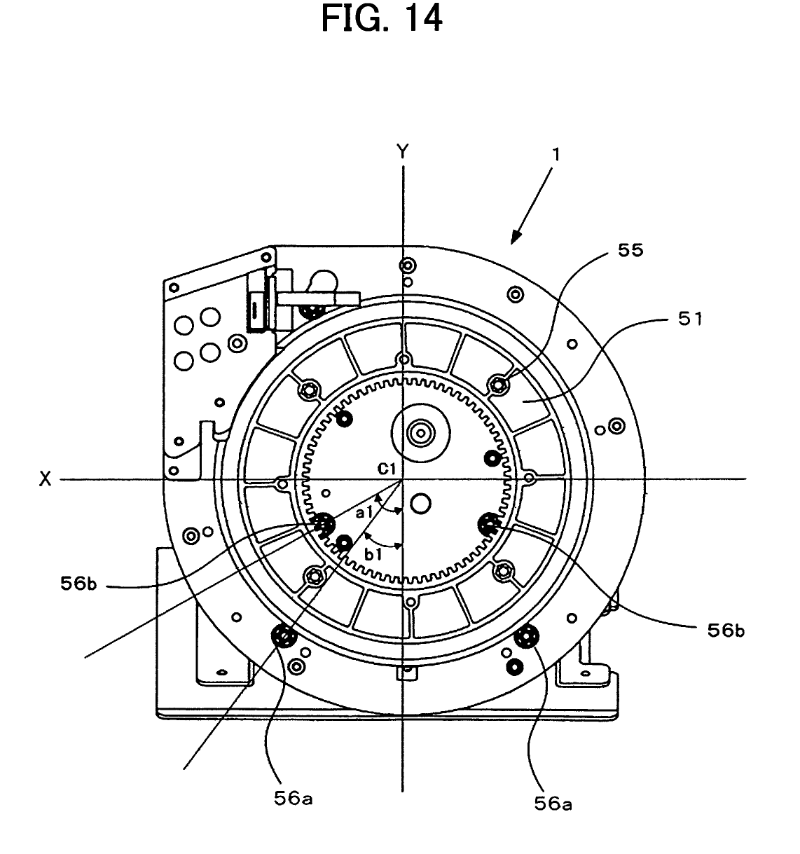

Next, in FIG. 14, there will be explained a structure for corresponding to the change in a small size in the temperature and the humidity of the rotary 51.

The rotary 51 is formed of thermo-plastic resin (polyacetal). In particular, the polyacetal resin is subject to the effect of environmental changes such as temperatures and/or humidity, and the resin is easily affected by high absorption of moisture and the temperature change.

The rotary 51 is formed of the aforementioned polyacetal resin which minutely swells and shrinks under the influence of the change in the temperature and humidity. The value of change is on the order of 100 to 200μ but such value affects a smooth rotation of the rotary 51 and the rotary disc 50.

Consequently, even when the rotary 51 is largely affected by the change in the temperature and/or humidity, as shown in FIG. 14, at an allowable location which is not affected by the rotation and drive with respect to the bulging and shrinking of the rotor 51 there are provided on the rotor 51, outer guide rollers 56a and 56a which comes into contact with the outer circumference surface of the rotor 51 at a position lower than the central line x and which rotate on two fringes of the outer circumference surface in line symmetry with respect to the central line Y. As an angle b1 as seen from the central point C1 of the rotary 51, 37.5° on one side is preferable. Furthermore, there are provided on the inner circumference side surface of the rotary 51 inside guide rollers 56b and 56b which come into contact with the inner circumference side surface of the rotary 51 at a position lower than the central line X and which rotates on the fringe of the two inner circumference surfaces in line symmetry with respect to the central line Y of the rotary 51. As an angle a1 as seen from the central point C1 of the rotary 51, an angle of 62° on one side is preferable.

Here, the outer guide rollers 56a and 56a are shown such that the angle b1 as seen from the central point C1 of the rotary 51 is 37.5° on one side whereas inner guide roller 56a and 56b are shown such that the angle al as seen from the central point C1 of the rotary 51 is 62° on one side. However, the angles can be adjusted to appropriate degrees, and the angles are not necessarily set to the aforementioned set angles.

Therefore, outer guide rollers 56a and 56a and inside guide rollers 56b and 56b are provided on the rotary 51, so that the effect of the aforementioned polyacetal resin is alleviated.

That is, the rotary 51 is slightly bulged at high temperatures and humidity. Consequently, two outer guide rollers 56a and 56a and two inner rollers 56b and 56b are positioned and attached in order to minimize the effect of the change portion of the height and the inner diameter as a result of the bulging of the rotary 51 with two outer guide rollers 56a and 56a and two outer guide rollers 56b and 56b. In other words, the height of the rotary 51 is slightly heightened and raised because of the bulging of the rotary 51 from the position of the outer guide rollers 56a and 56a which contact the outer side surface of the rotary 51. Furthermore, the inner diameter is slightly enlarged. At the most appropriate attaching position of the outer guide rollers 56a and 56a, the change portion of the height of the rotary 51 is minimized. At the same time, the effect of the inner guide rollers 56b and 56b which contacts the inner circumference side surface of the rotary 51 is also minimized.

Furthermore, when the temperature and the humidity are low, the rotary 51 is slightly shrunken. Consequently, two inner guide rollers 56b and 56b and two outer guide rollers 56a and 56a are positioned and attached in order to minimize the effect of the height and the inner diameter as a result of the bulging of the rotary 51. In other words, the inner diameter of the rotary 51 is slightly reduced because of the shrinkage of the inner diameter of the rotary 51 from the position of the inner guide rollers 56b and 56b which contact the inner circumference side surface of the rotary 51. Furthermore, since the height of the rotary 51 is also slightly reduced, the rotary 51 is lowered as a whole. AT the most appropriate attaching position of the inner guide rollers 56b and 56b, the change portion of the inner diameter of the rotary 51 is minimized. At the same time, the effect of the outer guide rollers 56a and 56a which contact the outer side surfaces of the rotary 51 is also minimized.

Consequently, an unfavorable effect to the rotation drive with respect to the bulging and shrinking of the rotary 51 in the change in temperature and/or humidity is alleviated with the result that a smooth rotation drive is enabled with the rotary 51 being free from the effect with respect to the change in temperature and/or humidity.

Incidentally, in the aforementioned embodiment, the Embodiments 1 and 2 according to the coin hopper of the present invention have been explained. However, the present invention is not limited to the aforementioned embodiment. The present invention can be changed and improved in various manners within the scope of not deviating from the gist thereof.

A rotary disc provided with a plurality of coin anchor pins on a disc rotatably and detachably on a main body of the hopper, a fixed guide attached and fixed to the main body of the hopper via the rotary disc, and an agitator whose center of rotation is moved with respect to the coaxial center of the rotary disc and the fixed guide via the fixed guide with the result that coins which are in bulk stacked in the hopper bowl can be efficiently agitated and moved and the coins can be efficiently transported with the agitation thereof.

1. A coin hopper comprising:
a hopper bowl for storing coins in bulk stacked state;
a rotary disc for receiving an dispensing the coins one by one in the hopper bowl between a plurality of coin anchors which is inclined in an upward direction at predetermined angle and which is arranged in a predetermined distance;
a fixed guide which has a smaller diameter than the rotary disc and has a concentric configuration with the rotary disc and which is projected in a predetermined amount toward the side of the hopper bowl of the rotary disc; and
an agitator which is projected in a predetermined amount toward the side of the hopper bowl than the fixed guide to be located on a lower side with respect to the rotation shaft of the rotary disc.

2. The coin hopper according to claim 1, wherein the agitator is moved to the side of the rotation direction of the rotary disc and is rotatably provided in the same direction as the rotary disc.

3. The coin hopper according to claim 1, wherein the agitator is rotatably provided in the same direction as the rotary disc on the center of the axis fixed to the main body of the hopper.

4. The coin hopper according to claim 1, wherein the agitator has a plurality of arms which extended in a radial direction.

5. The coin hopper according to claim 1, wherein the arms have sharp end sections having an acute angle toward the tip thereof.

6. The coin hopper according to claim 5, wherein coin escape surfaces are formed which form an escape angle toward the coin contact portion on the side of the arm.

7. The coin hopper according to claim 1, wherein the fixed guide is formed by forming a horizontal coin transport guide which extends in a direction of a tangent line on the outer circumference of the rotary disc and the upper section of the round coin transport guide which forms the coin transport passage.

8. The coin hopper according to claim 7, wherein a different piece which can be exchanged is provided on the tip section of the horizontal coin transport guide. the tip section of the horizontal coin transport guide.

9. The coin hopper according to claim 8, wherein a dispensing roller is arranged which can be moved so that the dispensing roller can be elastically brought back in a downward direction toward the horizontal coin transport guide at the time of the passage of the coins toward the horizontal coin transport guide.

10. The coin hopper according to claim 1, wherein a chute is provided on the side of the coin transport port of the main body of the hopper, and a coin transport passage is provided which comprises the inner surface of the chute and the upper surface of the main body of the hopper on the chute.

11. The coin hopper according to claim 1, wherein the agitator is formed in such a manner that the agitator is rotated with a drive gear provided on an output shaft of a motor arranged on the main body of the hopper, a transmission gear which comprises a second transmission gear which is integrally formed with the first transmission gear engaging the drive gear and the axis rotatably supporting the transmission gear, and the transmission inner tooth gear engaging with the second transmission gear is provided so as to rotate in the same direction as the agitator via the transmission inner tooth gear which is engaged with the second transmission gear.

12. The coin hopper according to claim 1, wherein a rotary disc is provided, and a transmission gear inner tooth gear are provided on the inside of the rotary disc, and a drive gear and a transmission gear are provided in an inner circle of the rotary disc, and a one-way clutch is fixed to the central shaft of the transmission gear.

13. The coin hopper according claim 1, wherein the rotary disc provided detachably on the main of the aforementioned hopper and fixed guide which is detachably provided can be exchanged with the rotary disc for exchange having a plurality of coin anchor which are arranged in distance corresponding to a predetermined coin at each position, and the fixed guide for exchange corresponding to the rotary disc for exchange.

14. The coin hopper according to claim 1, wherein the coin hopper has a slider provided on the rear surface of the main body of the hopper, the slider functioning as a position adjustment mechanism of a coin sensor for a different diameter of coins, and the coin sensor for counting coins which sensor is attached on the coin sensor attaching section provided on the slider, and the coin sensor also has a handle which is rotatably fixed to the cum sandwiching the cum for moving up and down the slider provided on a lower position of the slider provided on the coin sensor and a support side wall section.

15. The coin hopper according to claim 14, wherein the coin hopper has a projecting section provided at the end of the handle, and a plurality of notch holes penetrated into the support side wall which allows the insertion of the projecting section at the time of fixing the position of the slider which is integral with the coin sensor.

16. The coin hopper according to claim 14, wherein the coin sensor is provided at a position which is not projected toward the coin transport passage, and the coin transport passage is arranged in an appropriate distance with respect to the dispensing roller.

17. The coin hopper according to claim 14, wherein the coin sensor is connected to the unallowable coins blocking piece and the coin sensor moves in a direction perpendicular to the upper surface of the inner surface of the chute or the upper surface of the main body of the hopper so as to run at right angle with the coin transport passage in association with the unallowable coins blocking piece.

18. The coin hopper according to claim 1, wherein since the rotary assembled with the rotary disc are bulged and shrunken owing to temperature and humidity, an inside guide roller and an outer guide roller are provided in order to absorb the change section of the rotary, the inner guide rollers being provided in plurality in close contact with the inner circumference side surface of the rotary, the outer guide roller being provided in plurality in close contact with the outer circumference side surface of the rotary.

19. The coin hopper according to claim 15, wherein the coin sensor is connected to the unallowable coins blocking piece and the coin sensor moves in a direction perpendicular to the upper surface of the inner surface of the chute or the upper surface of the main body of the hopper so as to run at right angle with the coin transport passage in association with the unallowable coins blocking piece.

20. The coin hopper according to claim 16, wherein the coin sensor is connected to the unallowable coins blocking piece and the coin sensor moves in a direction perpendicular to the upper surface of the inner surface of the chute or the upper surface of the main body of the hopper so as to run at right angle with the coin transport passage in association with the unallowable coins blocking piece.
